(19) United States
(12) Patent Application Publication
(10) Pub. No.: US 2011/0058099 A1
(43) Pub. Date: Mar. 10, 2011

(54) ROTATABLE CAMERA MODULE FOR ELECTRONIC DEVICE

(75) Inventor: CHENG-YI LAI, Tu-Cheng (TW)

(73) Assignee: HON HAI PRECISION INDUSTRY CO., LTD., Tu-Cheng (TW)

(21) Appl. No.: 12/695,245

(22) Filed: Jan. 28, 2010

(30) Foreign Application Priority Data
Sep. 10, 2009 (CN) 200910306859.4

(51) Int. Cl. H04N 5/225

(52) U.S. Cl. 348/373; 348/E05.024

(57) ABSTRACT

A camera module for an electronic device includes a holder, a supporting member, an image sensor, and a lens module. The holder is fixed to the electronic device and includes an inner surface. The holder defines a truncated spherical receiving space surrounded by the inner surface and an opening communicating with the receiving space. The supporting member includes a connecting portion and supporting portion. The connecting portion is received in the receiving space and rotatable relative to the holder. The supporting portion extends out of the receiving space from the opening and is rotatable together with the connecting portion. The image sensor is fixed on the supporting portion and is electrically connected to the electronic device. The lens module is fixed on the supporting portion and is aligned with the image sensor.

### BACKGROUND

1. Technical Field

The present disclosure relates to camera modules and, particularly, to a rotatable camera module for an electronic device capable of rotating relative to the electronic device.

2. Description of Related Art

Many electronic devices, such as mobile phones, PDAs, etc. have embedded camera modules. Most of the camera modules are fixed in a stationary position and the user must rotate the whole electronic device when they want to change the viewing angle. This is inconvenient for users using the electronic device.

What is needed, is a rotatable camera module for electronic devices to overcome or at least mitigate the above described problem.

### BRIEF DESCRIPTION OF THE DRAWINGS

Many aspects of the present rotatable camera module can be better understood with reference to the accompanying drawings. The components in the drawings are not necessarily drawn to scale, the emphasis instead being placed upon clearly illustrating the principle of the rotatable camera module. In the drawings, all the views are schematic.

FIG. 1 is an isometric view of an electronic device according to an exemplary embodiment.

FIG. 2 is an assembled, isometric view of a rotatable camera module according to an exemplary embodiment.

FIG. 3 is an exploded, isometric view of the rotatable camera module of FIG. 2.

FIG. 4 is a sectional view of the rotatable camera module of FIG. 2.

### DETAILED DESCRIPTION

Embodiments of the present disclosure will now be described in detail below, with reference to the accompanying drawings.

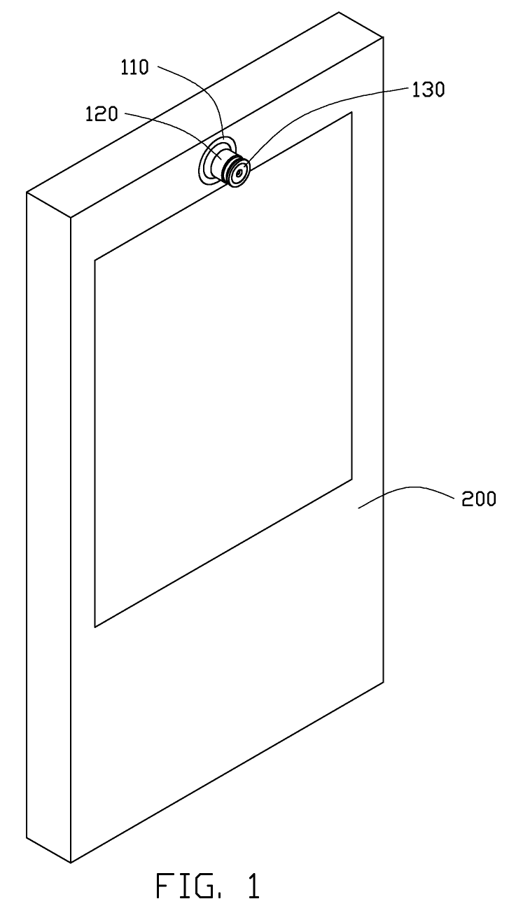

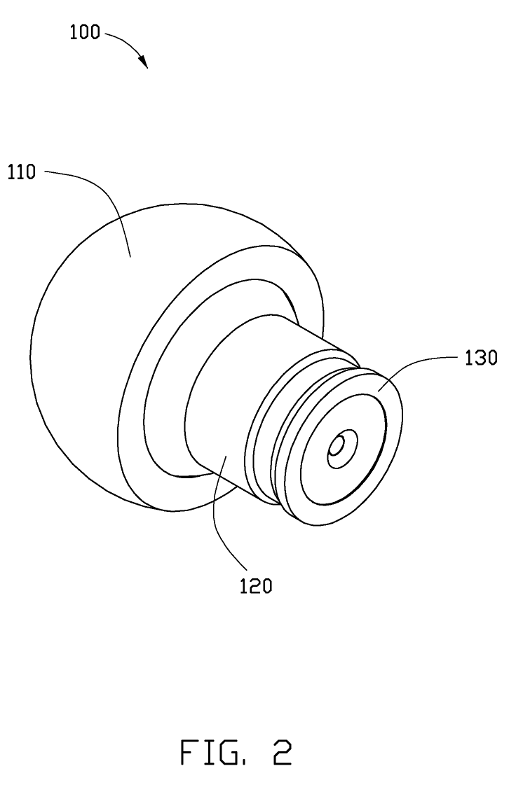

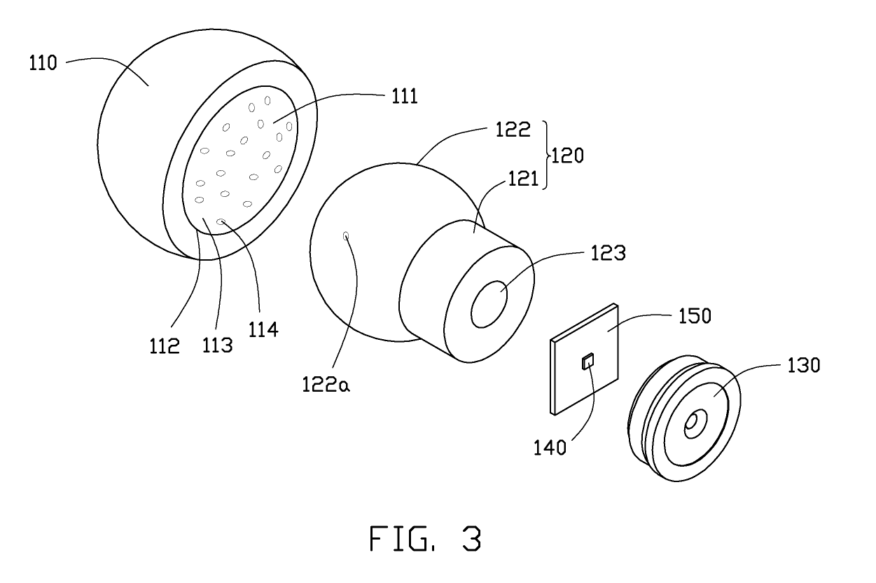

Referring to FIGS. 1 to 3, a camera module 100 for an electronic device 200, is shown. The camera module 100 includes a holder 110, a supporting member 120, a lens module 130, an image sensor 140, and a circuit board 150. The electronic device 200 can be a mobile phone, a notebook computer etc.

The holder 110 is fixed to the electronic device 200. The holder 110 defines a truncated spherical receiving space 111 surrounded by an inner surface 113 and an opening 112 communicating with the receiving space 111. The truncated spherical receiving space 111 is larger than a hemisphere of a virtual sphere formed by extending the inner surface 113 of the holder 110. In the present embodiment, the holder 110 is a truncated spherical shell larger than a hemisphere of a virtual sphere formed by extending the outer surface of the truncated spherical shell. The opening 112 is round and has a diameter smaller than that of the receiving space 111. The holder 110 can be made of elastic material, thus, the diameter of the opening 112 can be increased. The holder 110 further defines a number of positioning holes 114 on the inner surface 113 of the holder 110.

The supporting member 120 includes a supporting portion 121 and a connecting portion 122. The connecting portion 122 is received in the receiving space 111 of the holder 110 and is rotatable relative to the holder 110. The supporting portion 121 extends out of the receiving space 111 of the holder 110 from the opening 112, and can rotate together with the connecting portion 122.

The connecting portion 122 is substantially spherical and has a diameter substantially equal to that of the receiving space 111. In the present embodiment, because the holder 110 is made of elastic material and the diameter of the opening 112 is increasable, in assembly, the connecting portion 122 can be pressed into the receiving space 111 of the holder 110 through the opening 112 conveniently. In the present embodiment, the connecting portion 122 further includes a hump 122a formed on the surface of the connecting portion 122. The hump 122a can increase the friction between the connecting portion 122 and the holder 110, firmly holding the connecting portion 122 in a steady position by latching with each of the positioning holes 114 on the inner surface 113 of the holder 110. It should be understood that there could be a plurality of humps 122a on the connecting portion 122.

The lens module 130, the image sensor 140, and the circuit board 150 are fixed on the supporting portion 121 of the supporting member 120. The image sensor 140 is mounted on and electrically connected to the circuit board 150. The lens module 130 is aligned with the image sensor 140 for forming images of objects on the image sensor 140.

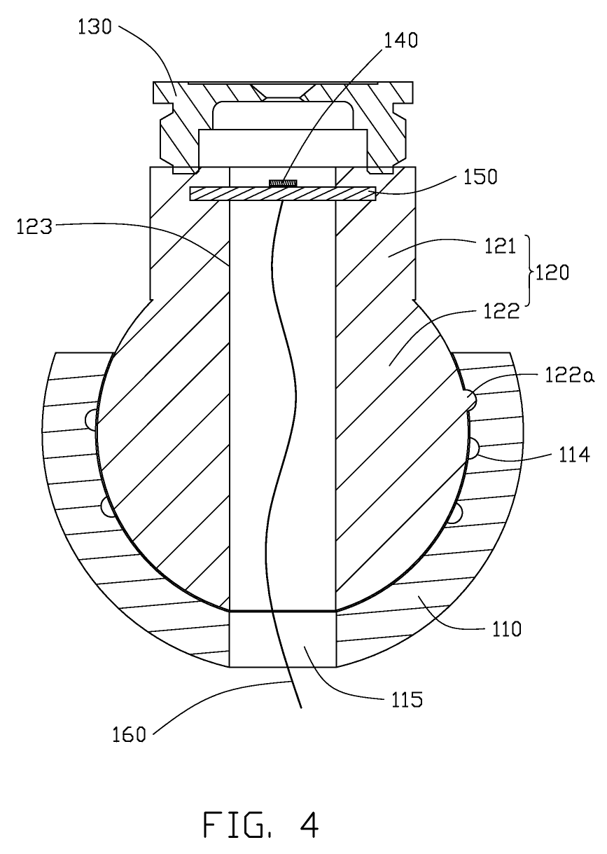

Further referring to FIG. 4, the holder 100 further defines a through hole 115 opposite to the opening 112, and the supporting member 120 further defines a wire hole 123 communicating with the through hole 115. The camera module 100 as well includes a wire 160 passing through the through hole 115 and the wire hole 123 for electrically connecting the circuit board 150 to the electronic device 200, assuring the image signals captured by the image sensor 140 can be transmitted into the electronic device 200.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A camera module for an electronic device comprising:
a holder for being fixed to the electronic device, the holder comprising an inner surface, and defining a truncated spherical receiving space surrounded by the inner surface and an opening communicating with the receiving space, the receiving space being larger than a hemisphere of a virtual sphere formed by extending the inner surface of the holder;
a supporting member comprising:
a connecting portion received in the receiving space and rotatable relative to the holder, the connecting portion being substantially spherical and having a diameter substantially equal to that of the receiving space; and
a supporting portion extending out of the receiving space from the opening and rotatable together with the connecting portion,
an image sensor fixed on the supporting portion and electrically connected to the electronic device; and
a lens module fixed on the supporting portion and aligned with the image sensor.

2. The camera module as claimed in claim 1, wherein the image sensor is located outside the receiving space.

3. The camera module as claimed in claim 1, wherein the holder is a truncated spherical shell larger than a hemisphere of a virtual sphere formed by extending the outer surface of the truncated spherical shell.

4. The camera module as claimed in claim 1, wherein the opening is round and has a diameter smaller than that of the receiving space.

5. The camera module as claimed in claim 1, wherein the holder is made of elastic material.

6. The camera module as claimed in claim 1, wherein the holder further defines a plurality of positioning holes on the inner surface thereof, and the connecting portion comprising at least one hump capable latching with the positioning holes.

7. The camera module as claimed in claim 1, further comprising a circuit board fixed on the supporting portion of the supporting member, and the image sensor being mounted on the circuit board and being electrically connected to the circuit board.

8. The camera module as claimed in claim 6, further comprising a wire for electrically connecting the circuit board to the electronic device.

9. The camera module as claimed in claim 8, wherein the holder further defines a through hole opposite to the opening thereof, the supporting member further defines a wire hole communicating with the through hole, and the wire passing through the through hole and the wire hole for electrically connecting the circuit board to the electronic device.

10. An electronic device assembly comprising:
an electronic device, and
a camera module comprising:
a holder fixed to the electronic device, the holder comprising an inner surface, and defining a truncated spherical receiving space surrounded by the inner surface and an opening communicating with the receiving space, the receiving space being larger than a hemisphere of a virtual sphere formed by extending the inner surface of the holder;
a supporting member comprising:
a connecting portion received in the receiving space and rotatable relative to the holder, the connecting portion being substantially spherical and having a diameter substantially equal to that of the receiving space; and
a supporting portion extending out of the receiving space from the opening and rotatable together with the connecting portion,
an image sensor fixed on the supporting portion and electrically connected to the electronic device; and
a lens module fixed on the supporting portion and aligned with the image sensor.

11. The electronic device as claimed in claim 10, wherein the electronic device is a mobile phone or a notebook computer.

12. The electronic device as claimed in claim 10, wherein the holder is a truncated spherical shell larger than a hemisphere of a virtual sphere formed by extending the outer surface of the truncated spherical shell.

13. The electronic device as claimed in claim 10, wherein the opening is round and has a diameter smaller than that of the receiving space.

14. The electronic device as claimed in claim 10, wherein the holder is made of elastic material.

15. The electronic device as claimed in claim 10, wherein the holder further defines a plurality of positioning holes on the inner surface thereof, and the connecting portion comprising at least one hump capable latching with the positioning holes.

16. The electronic device as claimed in claim 10, further comprising a circuit board fixed on the supporting portion of the supporting member, and the image sensor being mounted on the circuit board and being electrically connected to the circuit board.

17. The electronic device as claimed in claim 16, further comprising a wire electrically connected the circuit board to the electronic device.

18. The electronic device as claimed in claim 17, wherein the holder further defines a through hole opposite to the opening thereof, the supporting member further defines a wire hole communicating with the through hole, and the wire passing through the through hole and the wire hole for electrically connected the circuit board to the electronic device.
